(19) United States
(12) Patent Application Publication
(10) Pub. No.: US 2025/0289705 A1
(43) Pub. Date: Sep. 18, 2025

(54) MULTIFUNCTIONAL WATER DISPENSING SYSTEM AND WATER DISPENSER

(71) Applicant: Xiamen Filtertech Industrail Corporation, Xiamen (CN)

(72) Inventors: Kunbin CHEN, Xiamen (CN); Jinsen TU, Xiamen (CN); Jiajia LIN, Xiamen (CN); Weiqiang XU, Xiamen (CN)

(73) Assignee: Xiamen Filtertech Industrail Corporation, Xiamen (CN)

(21) Appl. No.: 19/001,615

(22) Filed: Dec. 26, 2024

(30) Foreign Application Priority Data
Mar. 15, 2024 (CN) 202420511763.1

(51) Int. Cl. B67D 1/12; B67D 1/00; B67D 1/08

(52) U.S. Cl. CPC B67D 1/1204; B67D 1/0014; B67D 1/0895; B67D 2210/0001

(57) ABSTRACT

A multifunctional water dispensing system and a water dispenser relate to the technical field of water dispensers. The system includes a water feeding channel, a first, a second and a third water dispensing channels, each water dispensing channel connecting to a water dispensing component; the connection and disconnection between each water dispensing channel and the water feeding channel are controlled by a control component; the second water dispensing channel is provided with a heat storage tank and a hot water flow regulator, and the third water dispensing channel is provided with a cold water flow regulator; and the two flow regulators are electrically connected to the control component and driven by the control component to regulate a ratio of cold water to hot water, so as to regulate a temperature of mixed water. This application solves the issue of single-function inconvenience in current dispensers.

### CROSS REFERENCE TO THE RELATED APPLICATIONS

This application is based upon and claims priority to Chinese Patent Application No. 202420511763.1, filed on Mar. 15, 2024, the entire contents of which are incorporated herein by reference.

### TECHNICAL FIELD

The present application relates to the technical field of water dispensers, and specifically to a multifunctional water dispensing system and a water dispenser.

### BACKGROUND

Existing water dispensers have a single function and usually only supply cold water or hot water. When warm water is required, users need to wait for the hot water to cool down, or add cold water to hot water and mix them manually, which is inconvenient for users.

### SUMMARY

The present application discloses a multifunctional water dispensing system, which aims to resolve the problem that the existing water dispensers have a single function and are inconvenient for users.

The present application adopts the following technical solutions.

A multifunctional water dispensing system includes a water feeding channel, a first water dispensing channel, a second water dispensing channel, and a third water dispensing channel; each of the water dispensing channels is connected to a water dispensing component, and the connection and disconnection between each water dispensing channel and the water feeding channel are controlled by a control component; the second water dispensing channel is provided with a heat storage tank and a hot water flow regulator, and the third water dispensing channel is provided with a cold water flow regulator; and the two flow regulators are electrically connected to the control component and are driven by the control component to regulate a feeding ratio of cold water to hot water, so that a temperature of mixed water is regulated.

As a further improvement, each of the water dispensing channels is provided with a solenoid valve, each solenoid valve is electrically connected to a control component, when a solenoid valve on the first water dispensing channel is opened, the water feeding channel is communicated with the first water dispensing channel, and cold water is discharged from the water dispensing component; when a solenoid valve on the second water dispensing channel is opened, the second water dispensing channel is communicated with the water feeding channel, and hot water is discharged from the water dispensing component; and when both the solenoid valve on the second water dispensing channel and the solenoid valve on the third channel are opened, the second water dispensing channel and the third water dispensing channel are communicated with the water feeding channel, and mixed water is discharged from the water dispensing component.

As a further improvement, the water feeding channel includes a filtering line, and the filtering line is sequentially provided with a switch valve, a water feeding valve, a booster pump, a reverse osmosis filter element, a flow meter, and a first temperature sensor along a water flow direction.

As a further improvement, the second water dispensing channel is sequentially provided with a heat storage tank, a water pump, a flow meter, and a first one-way valve along a water flow direction.

As a further improvement, the third water dispensing channel is sequentially provided with the cold water flow regulator and a second one-way valve along a water flow direction.

As a further improvement, both the second water dispensing channel and the third water dispensing channel are connected to a water dispensing component by a water dispensing flow path, and the water dispensing flow path is provided with a second temperature sensor.

As a further improvement, a heater, a third temperature sensor, a high liquid level sensor, and a low liquid level sensor are arranged in the heat storage tank, and an exhaust channel of the heat storage tank is connected to the water dispensing component.

As a further improvement, a waste water channel of the reverse osmosis filter element is provided with a waste water valve and a third one-way valve, and the waste water valve is electrically connected to the control component.

As a further improvement, the filtering line is provided with a backflow line, the backflow line connects to the upstream of the booster pump from the downstream of the reverse osmosis filter element, and the backflow line is sequentially provided with a backflow valve and a fourth one-way valve along a water flow direction.

A water dispenser is further provided and includes a water dispenser body and a multifunctional water dispensing system provided on the water dispenser body, wherein the multifunctional water dispensing system is the multifunctional water dispensing system described above.

With the above technical solutions, the present application can achieve the following technical effects.

According to the multifunctional water dispensing system of the present application, when a user selects cold water, a control component drives a first water dispensing channel to open, so that clean water flows to a water dispensing component from the first water dispensing channel; when a user selects hot water, a control component drives a second water dispensing channel to open, so that clean water flows out after being heated by a heat storage tank; and when a user selects mixed water, both a second water dispensing channel and a third water dispensing channel are opened, and a feeding ratio of the cold water to the hot water is adjusted by a hot water flow regulator and a cold water flow regulator, so that the temperature adjustment of the mixed water is achieved. The present application can supply cold water, hot water and mixed water, has rich functions, and can meet the use requirements of users in different scenarios.

### BRIEF DESCRIPTION OF THE DRAWINGS

To describe the technical solutions in embodiments of the present application more clearly, the following briefly describes the accompanying drawings used for describing embodiments. It should be understood that the accompanying drawings show only some embodiments of the present application, and therefore should not be considered as a limitation on the scope. Those of ordinary skill in the art may still derive other related drawings from these accompanying drawings without creative efforts.

FIG. 1 is a schematic diagram of a system of an embodiment according to the present application; and

FIG. 2 is a schematic diagram of a structure of an embodiment according to the present application.

Reference numbers: 100: filtering line; 200: first water dispensing channel; 300: second water dispensing channel; 400: third water dispensing channel;
1: switch valve; 2: water feeding valve; 3: fourth one-way valve; 4: backflow valve; 5: reverse osmosis filter element; 6: flow meter; 7: first temperature sensor; 8: first solenoid valve; 9: second solenoid valve; 10: water dispensing component; 11: second temperature sensor; 12: high liquid level sensor; 13: low liquid level sensor; 14: first one-way valve; 15: second one-way valve; 16: flow meter; 17: water pump; 18: heater; 19: heat storage tank; 20: third temperature sensor; 21: cold water flow regulator; 22: third solenoid valve, 23: booster pump; 24: waste water valve; and 25: third one-way valve.

### DETAILED DESCRIPTION OF THE EMBODIMENTS

To make the purpose, technical solutions, and advantages of the embodiments of the present application clearer, the technical solutions in the embodiments of the present application will be clearly and completely described below with reference to the accompanying drawings in the embodiments of the present application. It is apparent that the described embodiments are merely a part rather than all of embodiments of the present application. Based on the embodiments of the present application, all other embodiments obtained by those of ordinary skill in the art without creative efforts fall within the protection scope of the present application. Therefore, the following detailed descriptions of embodiments of the present application provided in the accompanying drawings are not intended to limit the scope of the present application that claims protection, but merely to represent selected embodiments of the present application. Based on the embodiments of the present application, all other embodiments obtained by those of ordinary skill in the art without creative efforts fall within the protection scope of the present application.

### Embodiments

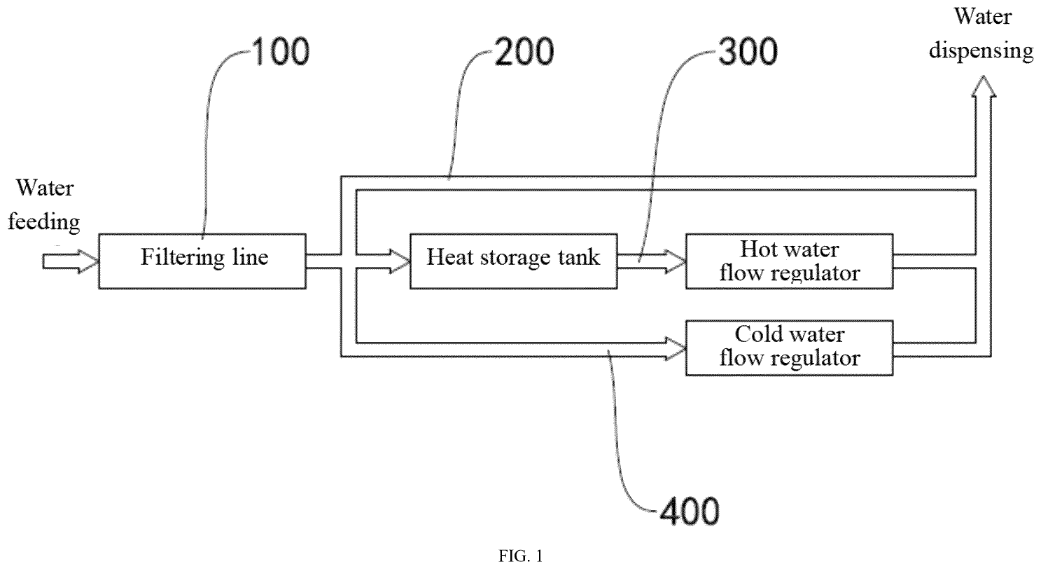

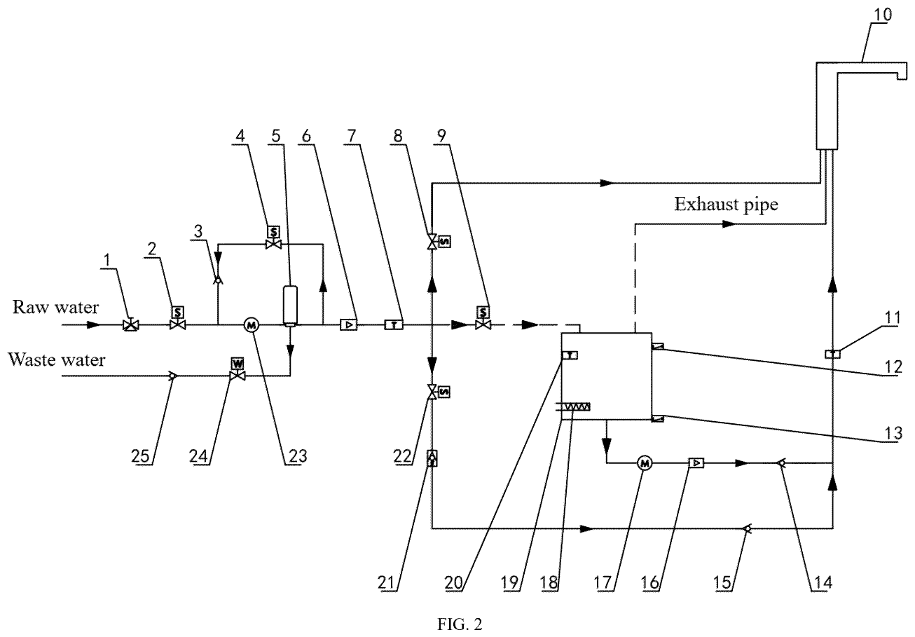

Referring to FIG. 1 and FIG. 2, this embodiment provides a multifunctional water dispensing system, which includes a water feeding channel, a first water dispensing channel 200, a second water dispensing channel 300, and a third water dispensing channel 400; each of the water dispensing channels is connected to a water dispensing component 10, and the connection and disconnection between each water dispensing channel and the water feeding channel are controlled by a control component; the second water dispensing channel 300 is provided with a heat storage tank 19 and a hot water flow regulator, and the third water dispensing channel 400 is provided with a cold water flow regulator 21; and the two flow regulators are electrically connected to the control component and are driven by the control component to regulate a feeding ratio of cold water to hot water, so that a temperature of mixed water is regulated.

It should be noted that the control component includes a circuit board and a human-computer interaction interface, wherein the structure and the circuit principle between the circuit board and the human-computer interaction interface are the prior art, and are not described herein again.

Illustratively, each of the water dispensing channels is provided with a solenoid valve, and each solenoid valve is electrically connected to a control component. For example, the first water dispensing channel 200 is provided with a first solenoid valve 8, the second water dispensing channel 300 is provided with a second solenoid valve 9, and the third water dispensing channel 400 is provided with a third solenoid valve 22. When the first solenoid valve 8 is opened, the first water dispensing channel 200 is communicated with the water feeding channel, and cold water is discharged from the water dispensing component 10; when the second solenoid valve 9 is opened, the second water dispensing channel 300 is communicated with the water feeding channel, and hot water is discharged from the water dispensing component 10; and when both the second solenoid valve 9 and the third solenoid valve 22 are opened, the second water dispensing channel 300 and the third water dispensing channel 400 are both communicated with the water feeding channel, and mixed water is discharged from the water dispensing component 10.

It should be noted that, in this embodiment, when the user selects cold water on the human-computer interaction interface of the control component, the control component drives the first water dispensing channel 200 to open, so that clean water flows from the first water dispensing channel 200 to the water dispensing component 10; and when the user selects hot water, the control component drives the second water dispensing channel 300 to open, and the clean water is pumped out by a water pump 17 after being heated by the heat storage tank 19 so as to ensure the water dispensing power. When a user selects mixed water, both the second water dispensing channel 300 and the third water dispensing channel 400 are opened, and a feeding ratio of the cold water to the hot water is adjusted by a hot water flow regulator and a cold water flow regulator 21, so that the temperature adjustment of the mixed water is achieved. In summary, this embodiment has the functions of reverse osmosis filtration, cold water, hot water, and mixed water supply, making it well-suited to meet the users' requirements in different scenarios.

In a preferred embodiment, the water feeding channel includes a filtering line 100, and raw water is filtered by the filtering line 100 to obtain clean water. Specifically, the filtering line 100 is sequentially provided with a switch valve 1, a water feeding valve 2, a booster pump 23, a reverse osmosis filter element 5, a flow meter 6, and a first temperature sensor 7 along a water flow direction. The switch valve 1 is preferably a ball valve, the transmission power of the water flow is ensured by the booster pump 23, the reverse osmosis filter element 5 can be a filter element with an RO reverse osmosis membrane, a waste water channel of the reverse osmosis filter element 5 is provided with a waste water valve 24 and a third one-way valve 25, and the waste water valve 24 is electrically connected to the control component. Of course, in other embodiments, the water feeding channel may not be provided with the filtering line 100, and only a channel with a water feeding function is provided.

Preferably, the filtering line 100 is provided with a backflow line, the backflow line connects to the upstream of the booster pump 23 from the downstream of the reverse osmosis filter element 5, and the backflow line is sequentially provided with a backflow valve 4 and a fourth one-way valve 3 along a water flow direction. When the control component drives the backflow valve 4 to open, the water flows back and is filtered again to obtain better quality water, thereby ensuring healthy drinking water. The water feeding valve 2, the waste water valve 24, and the backflow valve 4 are preferably solenoid valves, and may be other electrically controlled valves, which are not limited thereto and are not particularly limited.

Based on the above embodiments, in an optional embodiment of the present application, the hot water flow regulator includes a water pump 17 and a flow meter 16, and the second water dispensing channel 300 is sequentially provided with a heat storage tank 19, the water pump 17, the flow meter 16, and a first one-way valve 14 along a water flow direction. The water flow is measured by the flow meter 16, and the power of the water pump 17 is controlled by the control component, so that hot water with different flow rates is output. A heater 18, a third temperature sensor 20, a high liquid level sensor 12, and a low liquid level sensor 13 are arranged in the heat storage tank 19, a temperature of water in the heat storage tank 19 is monitored by the third temperature sensor 20, and the liquid level in the heat storage tank 19 is monitored by the liquid level sensor to ensure the supply of hot water. In this embodiment, the hot water capacity is increased by providing the heat storage tank 19, and the heating efficiency is improved by using the heater 18, thereby ensuring the flow rate of hot water. An exhaust channel of the heat storage tank 19 is connected to the water dispensing component 10, and hot air in the exhaust channel is exhausted by the water dispensing component 10, so that the structural design of the exhaust channel can be simplified, and the heating safety is ensured.

The third water dispensing channel 400 is sequentially provided with the cold water flow regulator 21 and a second one-way valve along a water flow direction 14. Both the second water dispensing channel 300 and the third water dispensing channel 400 are connected to the water dispensing component 10 by the water dispensing flow path, and the water dispensing flow path is connected to a water dispensing port on the water dispensing component 10, so that the number of lines in the water dispensing component 10 is reduced, and the line space is reduced. Meanwhile, the first water dispensing channel 200 is separated from the water dispensing flow path, so that cold water is separated from hot water, and the situation that a user drinks mixed hot and cold water is avoided. In addition, the water dispensing flow path is provided with a second temperature sensor 11, and a temperature of water in the water dispensing flow path is detected by the second temperature sensor 11. The first temperature sensor 7 is used to detect a temperature of clean water when water is dispensed, which is also a temperature of cold water. The second temperature sensor 11 is used to detect a temperature of water in the water dispensing flow path, which may be a temperature of hot water or mixed water. When mixed water is discharged, the control component can adjust the ratio of hot water to cold water by adjusting the hot water flow regulator and the cold water flow regulator 21 based on the mixed water temperature selected by the user, thereby achieving temperature regulation of the mixed water. The flow regulator may be a flow regulating valve, but is not limited thereto.

The present application further provides a water dispenser, which includes a water dispenser body and a multifunctional water dispensing system provided on the water dispenser body, wherein the multifunctional water dispensing system is the multifunctional water dispensing system according to any one of the foregoing embodiments. Illustratively, the water dispensing component 10 is a faucet, the control component is arranged on the faucet, and the human-computer interaction interface is arranged on a top surface of the faucet, which are not limited thereto and are not particularly limited.

The above are only preferred embodiments of the present application. The protection scope of the present application is not limited to the above embodiments. All technical solutions under the concept of the present application belong to the protection scope of the present application.

What is claimed is:

1. A multifunctional water dispensing system, comprising: a water feeding channel, a first water dispensing channel, a second water dispensing channel, and a third water dispensing channel;
wherein each of the first water dispensing channel, the second water dispensing channel and the third water dispensing channel is connected to a water dispensing component, and connection and disconnection between each of the first water dispensing channel, the second water dispensing channel and the third water dispensing channel and the water feeding channel are controlled by a control component; and
wherein the second water dispensing channel is provided with a heat storage tank and a hot water flow regulator, and the third water dispensing channel is provided with a cold water flow regulator; and the hot water flow regulator and the cold water flow regulator are electrically connected to the control component and are driven by the control component to regulate a feeding ratio of cold water to hot water, to regulate a temperature of mixed water.

2. The multifunctional water dispensing system according to claim 1, wherein each of the first water dispensing channel, the second water dispensing channel and the third water dispensing channel is provided with a solenoid valve, and the solenoid valve is electrically connected to the control component; when the solenoid valve on the first water dispensing channel is opened, the water feeding channel is communicated with the first water dispensing channel, and the cold water is discharged from the water dispensing component; when the solenoid valve on the second water dispensing channel is opened, the second water dispensing channel is communicated with the water feeding channel, and the hot water is discharged from the water dispensing component; and when both the solenoid valve on the second water dispensing channel and the solenoid valve on the third water dispensing channel are opened, the second water dispensing channel and the third water dispensing channel are communicated with the water feeding channel, and the mixed water is discharged from the water dispensing component.

3. The multifunctional water dispensing system according to claim 1, wherein the water feeding channel comprises a filtering line, and the filtering line is sequentially provided with a switch valve, a water feeding valve, a booster pump, a reverse osmosis filter element, a flow meter, and a first temperature sensor along a water flow direction.

4. The multifunctional water dispensing system according to claim 1, wherein the second water dispensing channel is sequentially provided with the heat storage tank, a water pump, a flow meter, and a first one-way valve along a water flow direction.

5. The multifunctional water dispensing system according to claim 4, wherein the third water dispensing channel is sequentially provided with the cold water flow regulator and a second one-way valve along the water flow direction.

6. The multifunctional water dispensing system according to claim 5, wherein both the second water dispensing channel and the third water dispensing channel are connected to the water dispensing component by a water dispensing flow path, and the water dispensing flow path is provided with a second temperature sensor.

7. The multifunctional water dispensing system according to claim 1, wherein a heater, a third temperature sensor, a high liquid level sensor, and a low liquid level sensor are arranged in the heat storage tank, and an exhaust channel of the heat storage tank is connected to the water dispensing component.

8. The multifunctional water dispensing system according to claim 3, wherein a waste water channel of the reverse osmosis filter element is provided with a waste water valve and a third one-way valve, and the waste water valve is electrically connected to the control component.

9. The multifunctional water dispensing system according to claim 3, wherein the filtering line is provided with a backflow line, the backflow line connects to an upstream of the booster pump from a downstream of the reverse osmosis filter element, and the backflow line is sequentially provided with a backflow valve and a fourth one-way valve along the water flow direction.

10. A water dispenser, comprising a water dispenser body and the multifunctional water dispensing system according to claim 1, wherein the multifunctional water dispensing system is provided on the water dispenser body.

11. The water dispenser according to claim 10, wherein in the multifunctional water dispensing system, each of the first water dispensing channel, the second water dispensing channel and the third water dispensing channel is provided with a solenoid valve, and the solenoid valve is electrically connected to the control component; when the solenoid valve on the first water dispensing channel is opened, the water feeding channel is communicated with the first water dispensing channel, and the cold water is discharged from the water dispensing component; when the solenoid valve on the second water dispensing channel is opened, the second water dispensing channel is communicated with the water feeding channel, and the hot water is discharged from the water dispensing component; and when both the solenoid valve on the second water dispensing channel and the solenoid valve on the third water dispensing channel are opened, the second water dispensing channel and the third water dispensing channel are communicated with the water feeding channel, and the mixed water is discharged from the water dispensing component.

12. The water dispenser according to claim 10, wherein in the multifunctional water dispensing system, the water feeding channel comprises a filtering line, and the filtering line is sequentially provided with a switch valve, a water feeding valve, a booster pump, a reverse osmosis filter element, a flow meter, and a first temperature sensor along a water flow direction.

13. The water dispenser according to claim 10, wherein in the multifunctional water dispensing system, the second water dispensing channel is sequentially provided with the heat storage tank, a water pump, a flow meter, and a first one-way valve along a water flow direction.

14. The water dispenser according to claim 13, wherein in the multifunctional water dispensing system, the third water dispensing channel is sequentially provided with the cold water flow regulator and a second one-way valve along the water flow direction.

15. The water dispenser according to claim 14, wherein in the multifunctional water dispensing system, both the second water dispensing channel and the third water dispensing channel are connected to the water dispensing component by a water dispensing flow path, and the water dispensing flow path is provided with a second temperature sensor.

16. The water dispenser according to claim 10, wherein in the multifunctional water dispensing system, a heater, a third temperature sensor, a high liquid level sensor, and a low liquid level sensor are arranged in the heat storage tank, and an exhaust channel of the heat storage tank is connected to the water dispensing component.

17. The water dispenser according to claim 12, wherein in the multifunctional water dispensing system, a waste water channel of the reverse osmosis filter element is provided with a waste water valve and a third one-way valve, and the waste water valve is electrically connected to the control component.

18. The water dispenser according to claim 12, wherein in the multifunctional water dispensing system, the filtering line is provided with a backflow line, the backflow line connects to an upstream of the booster pump from a downstream of the reverse osmosis filter element, and the backflow line is sequentially provided with a backflow valve and a fourth one-way valve along the water flow direction.
